(19) United States
(12) Patent Application Publication
(10) Pub. No.: US 2007/0010985 A1
(43) Pub. Date: Jan. 11, 2007

(54) Simulation and modelling method and apparatus

(75) Inventors: Robert Dale Anderson, Highbury (AU); Alister Mark Smith, Nailsworth (AU); Efthimies Gouthas, Holden Hill (AU); Michelle Charmain Dunn, Golden Grove (AU)

Correspondence Address: BEYER WEAVER & THOMAS, LLP, P.O. BOX 70250, OAKLAND, CA, 94612-0250, US

(73) Assignee: The Commonweath of Australia

(21) Appl. No.: 11/351,636

(22) Filed: Feb. 9, 2006

Related U.S. Application Data
(63) Continuation of application No. 10/027,835, filed on Dec. 20, 2001.
Application No. 10/027,835 is a continuation of application No. PCT/AU01/00462, filed on Apr. 20, 2001.

(30) Foreign Application Priority Data
Apr. 20, 2000 (AU) PQ 7106

(51) Int. Cl. G06F 9/45

(52) U.S. Cl. 703/22

(57) ABSTRACT

The invention is directed to a simulation and modelling approach, which comprises two parts. The first part comprises a generic mathematical model used to simulate or model a system and elements of the system interacting with a predetermined environment. The second part comprises at least one user defined data file that contains not only predetermined parameters (scalars values and/or tables with fixed independent variables) for use by the first part, but which also contains executable mathematical equations and respective data relating to an element of the system. These user-defined algorithmic expressions add to and complement the generic mathematical model so as to produce, when operating together numerical output that simulates or models the behaviour of the one or more elements of the system in a predetermined environment. Typically computer programs interact with the invention to provide a visualisation tools for the numerical output provided. The generic mathematical model can be changed to suit other environments and other elements (classes of objects) interacting with that environment

### CROSS REFERENCE TO RELATED APPLICATIONS

This application is a continuation of pending U.S. application Ser. No. 10/027,835, filed on Dec. 20, 2001, which is a continuation of PCT/AU01/00462, filed on Apr. 20, 2001, which claims priority to Australian Patent Application PO 7106, filed Apr. 20, 2000, all of which are incorporated by reference herein in their entirety for all purposes.

This invention relates generally to simulation and modelling.

### BACKGROUND

The science of modelling and simulation, by definition, requires compromise. Those skilled in the art use the term “fidelity” to describe how closely the model mimics reality. If a model provides output that is far from reality, the fidelity is low, and when a model provides output that is close to reality, the fidelity is considered to be high.

Of necessity, models rely on the formulation of mathematical equations having one or more variables, wherein the rule of thumb is that the larger the number of variables and the more complex the equation the more likelihood there is of good fidelity.

Sometimes simple models are better than none, as the model can then be said to be generic to a particular class of conditions, and sometimes very simple models are forced upon designers, because calculation time or power constraints apply.

However once a more complicated model is developed, it becomes less generic and the number of circumstances to which it can apply reduces to the extent that additional models are required for each circumstance if the highest fidelity is to be achieved.

Such an approach has the clear advantage that the fidelity of each simulation is good, but the disadvantage is that as fidelity increases so does the computational requirements as well as the quantity and accuracy of data used to support the model.

However, when large amounts of data are required for each model and circumstance, it can very quickly become unwieldy to create and maintain the data in a database. This complexity and difficulty increases more so for distributed application of the model particularly when the users of the application are widely separated geographically.

One way of better managing the association of data with particular circumstances is to use a mechanism in the generic model that can call up data (scalar values and/or tables with fixed independent variables) specific to the circumstance. That data is then available for execution by the one or more equations available in the generic model as and when required.

Thus modelling of this type has its advantages but clearly maintains the disadvantage of creating a specific database for each required circumstance that comprises rigidly structured data elements and their scalar value and key-word references. This type of modelling is the paradigm for known missile modelling and requires careful thought to ensure all possible scenarios are catered for. Such models become specific to particular missiles and exclude consideration of the use of the modelling architecture for other applications. An embodiment is provided herein relating to the simulation of airborne missiles comprising models for example of Air-to-Air (AAM) and Surface-to-Air (SAM) Missiles.

The invention described and disclosed in this specification which includes the claims aims to reduce or obviate the problems described herein.

The invention is directed to a simulation and modelling approach, which comprises two parts. The first part comprises a generic mathematical model used to simulate or model a system and elements of the system interacting with a predetermined environment. The second part comprises at least one user defined data file that contains not only predetermined parameters (scalars values and/or tables with fixed independent variables) for use by the first element, but which also contains executable mathematical equations and respective data relating to an element of the system. These user-defined algorithmic expressions add to and complement the generic mathematical model so as to produce, when operating together, numerical output that simulates or models the behaviour of the one or more elements of the system in a predetermined environment.

Typically computer programs interact with the invention to provide a visualisation tools for the numerical output provided. The generic mathematical model can be changed to suit other environments and other elements (classes of objects) interacting with that environment.

### BRIEF DESCRIPTION OF THE INVENTION

In a broad aspect the invention is a method for representing the behaviour of a system having at least one element, said system having

one or more generic descriptions each comprising predetermined characteristics that affect the behaviour of one or more elements of said system in a predetermined environment, and

a data file that contains one or more sets of numeric data and/or syntactic key words both related to said predetermined characteristics and/or a user defined algorithmic expressions, said method comprising the steps of:

a) calculating for a given interval using said generic description the behaviour of said system using data obtained from said data file; and

b) when said calculation does not use numeric data or a syntactic key word from said data file said user defined algorithmic expression is used to calculate the behaviour of said system.

In a further aspect of the invention a system for providing numerical output representative of the behaviour of a system comprises:

a first data storage means containing one or more generic system descriptions each having predetermined characteristics that affect the behaviour of said system in a predetermined environment;

a second data storage means containing at least one data file that contains one or more numeric data sets and/or one or more syntactic key words related to said predetermined characteristics and one or more user defined algorithmic expressions; and

a calculating means for using said first and second data storage means, wherein calculation using said generic description to obtain said behaviour of said system uses data obtained from said data file; and when said calculation does not use numeric data or a syntactic key word from said data file, said user defined algorithmic expression is used to calculate the behaviour of said system to provide said numerical output.

Specific embodiments of the invention will now be described in some detail with reference to and illustrated in the accompanying figures. These embodiments are illustrative, and not meant to be restrictive to the scope of the invention. Suggestions and descriptions of other embodiments may be included but they may not be illustrated in the accompanying figures or alternatively features of the invention may be shown on the figures, but not described in the specification.

### BRIEF DESCRIPTION OF THE FIGURES

FIG. 1 depicts a functional block diagram of the elements that can provide a working system for visualising the simulation of missile flight;

FIG. 2 depicts a functional block diagram of Missile Engagement and Analysis coverage and GEneric Missile Model elements of FIG. 1;

FIG. 3 provides a pictorial representation of the GEMM structure;

FIG. 4 pictorially represents the relationships between sub-components of GEMM;

FIG. 5 provides a pictorial representation of the MECA and GEMM virtual data bus;

FIG. 6 provides a representation of the data exchange between a missile data file, the data bus and the data manager;

FIG. 7 depicts a pictorial representation of the missile model and its interaction with portions of MECA;

FIG. 8 depicts a portion of an example missile data file;

FIG. 9 depicts a two-dimensional representation of a one-on-one air-to air missile combat simulation;

FIG. 10 depicts the program start-up sequence; and

FIG. 11 depicts selected code of a program start-up and run simulation associated with a one-on-one simulation.

### DESCRIPTION OF AN EMBODIMENT OF THE INVENTION

It is to be noted that the invention involves a Generic Object Modelling technique and only as an example of its use, the object class chosen to be modelled is a missile of the type used in the defence forces. However, in its broadest form the concept of the invention is applicable to a large variety of circumstances.

It should also be noted that the terms modelling and simulation will be used in this specification and where applicable they will have similar meanings. Although it is generally understood that whereas, simulation relates to the behaviour of a system including an object in the real world, modelling relates to the behaviour of a system including an object not necessarily in the real world.

For the purposes of pre-purchase evaluation and operational command training it is useful to simulate, in the digital environment, the performance of AAM's and SAM's. Simulation, as long as it has adequate fidelity, is particularly useful in the design process, and helps to reduce the time to evaluate new missiles in various scenarios, including active comparison with existing missiles. Simulation can also assist aircraft pilot and gunnery (air and ground based) training without the expense of real flying and missile launches which have unacceptable risks. It can also be used in the field in operational real time situations.

Missile Engagement and Coverage Analysis (MECA) is the common term used to describe the types of simulation described. In this specification the MECA software package is a tool developed for the analysis of AAM and SAM kinematic performance and its display using its own Graphical User Interface (GUI). The MECA application can be used to perform a number of simulation functions called scenarios. These are:
Single Engagement
Performance Contours
Range/Velocity/Latax (RVL)
Coverage Boundary

The GUI in MECA provides for the initialisation and visualisation of the simulation.

A broad view of the invention includes consideration of its application to any system having at least one element, the behaviour of which is to be determined by way of calculation, calculations that are dependant on the characteristics of the element and or system in a predetermined environment.

An embodiment described in this specification has as its system, a collection of airborne craft, elements of that system including various types of missiles. The environment is the air space above the ground while the ground surface forms a boundary to available air space.

The Generic Missile Model (GEMM) is a generic missile dynamics fly-out model and is used to generate data representative of the motion of a missile for further processing and eventual display using the abovementioned MECA program.

GEMM includes generic representations of the missile seeker, guidance system, propulsion system and airframe. GEMM also includes missile/shooter/target relative geometry calculations, environmental parameters including atmospheric, and equations of motion and numeric integration routines. GEMM itself does not contain any missile specific data. A component of GEMM (the Data Manager) has the capability to read and store missile specific data from missile data files. The missile data-files feature extremely flexible parameter definitions allowing GEMM to accurately represent an unlimited number of air-to-air and surface-to-air missiles.

In GEMM a data file is used as a repository of data relating to each object being modelled/simulated, such as a missile. A GEMM data file contains one or more of the following types of data; scalar values, tables with fixed independent variables, and pre-defined algorithmic expressions the later being termed herein “SMART DATA”.

The Smart Data concept is not restricted to missile simulations only. In fact it can be applied to many other types of data driven simulation. For example, a simulation of an aircraft might comprise a generic aircraft model (general mathematical equations representing aircraft dynamics and motion in terms of variables or parameters not specific to any particular aircraft) implemented as a computer program. Such a program is designed to read an aircraft-specific data file containing all of the parameters necessary to fully configure the generic model to represent a given aircraft type.

If the data file is restricted to contain only scalar values and tables with fixed independent variables, then the full potential of the this model is necessarily restricted. This is so because the equations that define the generic aircraft's behaviour are ‘hard-coded’ into the computer program and the ability to model or simulate the aircraft using a generic description is limited.

If the aircraft data file incorporates the Smart Data facility, then actual equations and ‘computer code’ make the data file more flexible and even more aircraft-specific. This allows the data file to provide a more accurate representation of a specific aircraft, which may also be dependent on other characteristics of the aircraft that were not originally considered and included in the design of the aircraft simulation program. Furthermore, it is possible for the user-defined code to cater for the representation of dynamic events that could not be predetermined. For example, the use of a new aircraft engine booster or air brake deceleration features, by simply calling up the relevant code for the aircraft-specific data file. Even more useful is the ability to call up the relevant code to be executed at the relevant time in the simulation.

In the chosen environment of missile modelling the performance of AAM's and SAM's can vary greatly dependent upon their launch conditions.

For SAM's, kinematic performance is dependent on the speed, altitude and manoeuvrability of the target. For AAM's, there exists the further complication, for modelling purposes, of there being a dependence on the speed and altitude of the launch aircraft.

In the past there was a need for a large number of sets of graphs which could be used, manually or by computer, to predict the SAM and AAM flight path for a selected number of initial conditions. When initial conditions lay between available graphs, users extrapolated the likely results.

The number of initial conditions is many and thus the number of graphs unwieldy to handle. Furthermore, when the objects to be modelled include a large variety of aircraft such as jets (F/A-18, F111-C), slower aircraft like transports (C-130, Caribou) and helicopters, the prior system was very difficult to use and equally difficult for defence personnel to maintain.

These difficulties were exacerbated when missile characteristics inevitably changed with technological improvements in the object being modelled, which necessitated the issue of updated graphs for all the new contingencies.

As computers became more widely used in the military the unwieldy nature of the many graphs began to disappear. A computer allows a very large amount of information to be stored and made almost instantaneously accessible to those with the relevant need whether that be for analysis or real time applications.

The ways in which known computer based simulators are implemented involves the use of either a general purpose or dedicated computing device, sometimes dedicated hardware and software supplied with initial and scenario related data and sometimes requires the use of classified missile characteristics. All of this data is called upon by the program(s) running on the computer device as required. Scalar values and tables having fixed independent variables can be called up by making key word references from the available missile data file.

Simulation programs of this type provide a dedicated calculation function as well as being associated with a dedicated results display application typically having a Graphical Usr Interface (GUI) so that the simulation can be easily populated with initial data and illustrated realistically.

Clearly, simulations that use precompiled software routines that run during each update cycle of the simulation are preferable, as this improves the speed of the large number of calculations involved in simulating high speed and complex objects such as aircraft and missiles.

If a simulator provides a simulation of one particular SAM then its characteristics would be predetermined and would preferably be precompiled into the code of the program. If enough of the various calculations are executable from the precompiled code simulation speeds can be optimised to suit the most demanding of scenarios especially those used by defence personnel in combat situations.

Some prior simulators recognise this advantage and are designed to provide a mechanism for reusing the often-used precompiled elements of the simulation. Unfortunately such an approach also requires the use of large amounts of uncompiled code and data, which adversely affects computation efficiency, and in general raises the need for raw computing power.

In addition to the compiled code to the computing power trade off, there is also a fidelity issue. The very complex calculations that take place are algorithmic and iterative and the higher the order of the iteration, the higher the accuracy of the results. If however, the computing power to perform high numbers of iteration is limited in any way, accuracy can be affected and the simulation less useful.

Furthermore, computing power availability and the time to run the simulation can vary during a simulation, thus the fidelity of the results may also be affected as the number of iterations may be dynamically limited to allow a particular computing device to handle all the simulation tasks particularly in real time circumstances.

As an example of the unpredictability of the computing load and the potential complexity of the simulation task, a good simulation should not only accurately predict a flight path, it should be able to replicate anti-missile measures such as Electronic Warfare (EW) jamming and its effect on the missile.

Such a demand on the simulator is not predictable in time or duration and to adequately account for all possible situations requires that there be vast computer resources available at all times.

One way of handling such limitations is to reduce the zone within which the simulation can occur and/or within which the parties to the simulation are able to detect certain missile events.

This compromise however, limits the reality of the simulation and trade offs of this type need to be carefully applied, as exceptions in a simulation may adversely affect the ability of the trained personnel to handle real life situations.

Thus the challenge for the designers of this invention was to create architecture for simulation and use modelling which took advantage of the available technology but which avoided or minimised the problems of prior simulation models. Particularly, there exists a need to have vast quantities of processing speed, power and resources. However, at the same time there is a need to create an easily maintained and secure database of missile and aircraft characteristics for military use. Although in developing the invention it has become apparent that the modelling technique described herein has many possible applications, and is not restricted to GEMM or the analysis and display of its output using MECA. In particular it is anticipated that the invention can be used as the input data generator for existing simulation programs and their legacy interfaces.

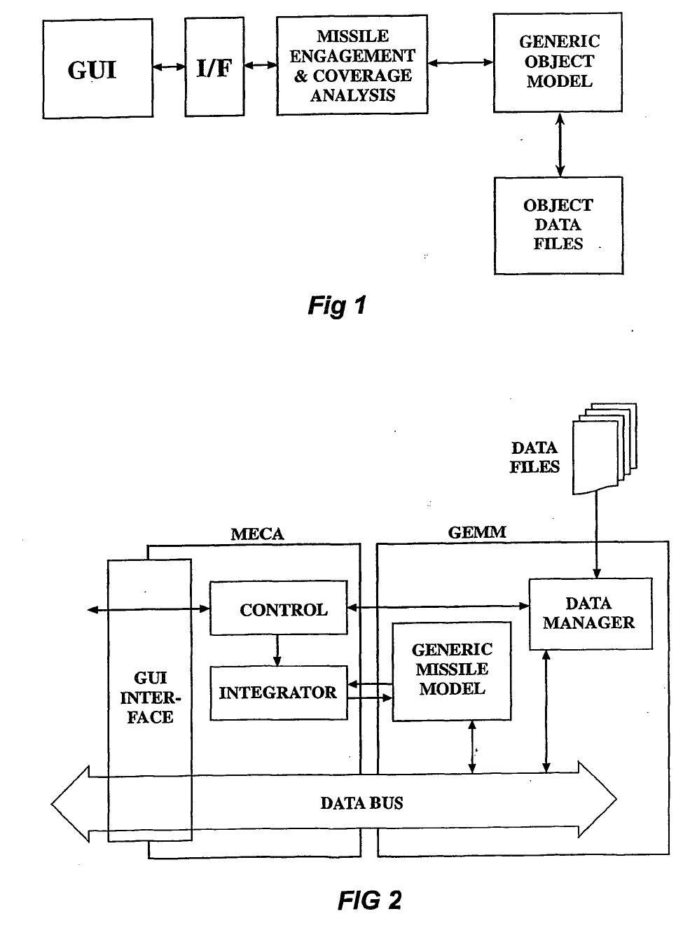

FIG. 1 depicts a schematic of the various elements that combine to create an embodiment of the invention.

A Graphical User Interface (GUI) is part of MECA but is shown separately to illustrate that it is an important part of MECA. The GUI receives and sends data from and to the Missile Engagement and Coverage Analysis (MECA) software module. The data that is sent could equally be received and used by other visualization modules representative of for example, an aircraft fighter training simulator, a missile flight simulator, a missile design tool, etc.

A GUI can be configured to work on a variety of computer operating systems and in a preferred embodiment the GUI is designed to execute in a Microsoft Windows.™. environment (eg Windows 3.x, 95/NT.™.).

The functional elements of the GUI are preferably provided by menu options and virtual buttons as well as context relevant help. A further preferable feature for a user is the provision of predetermined context relevant default values in the various fields to be set by the user. In addition to which it is possible for the user to chose between a variety of quantitative measurement units, such as between kilometers, meters or nautical miles for indicating distance.

It is also a preferred feature that the numerical and graphical results of the Missile Engagement and Coverage Analysis (MECA) software can be imported into Microsoft Windows.™. applications (eg. Word and Excel) to form the basis of graphs or spreadsheets or inserted via the Windows.™. Clipboard. The numerical results can also be saved to disk or the hard drive for re-opening at a later time. The results of a simulation can also be transferred to a Plot Workshop software program and may then be used to combine data generated by different scenarios into the one plot.

It is also useful for the MECA GUI output to include two-dimensional (2D) and three-dimensional (3D) graphical views, which can also be provided to various graphical windows on one or more screens for operator and/or multiple operator guidance.

In this embodiment the GUI is used to collect initial scenario data from the user so that MECA can use that data.

A Generic Missile Model uses a fixed set of mathematical equations to represent the forces acting on an object, in this example, a missile. The particular manner in which a missile is modelled is a matter of choice keeping in mind the fidelity and other requirements. In this embodiment a point-mass missile airfame is used or in other applications a know type of airframe. GEMM, in this embodiment, is written as a collection of C++ classes and is a collection of objects containing the required processing code such as the various equations. Member functions provide entry points to set the target and attacker state, and initialise and propagate the missile model. The missile-specific parameters that describe a particular missile are provided in a separate data file.

However, it should be noted that a GUI is not a required element. The MECA software tool, as is GEMM, are capable of running independent of each other. They can work with other programs when applying various equations to predetermined data representing various elements of a variety of systems or scenarios involving missiles and aircraft, to produce the kinematics (the numeric output that describes the behaviour) of each object. MECA working with GEMM could for example be used to develop and validate a missile parameter set.

The GUI allows a user to easily choose between various scenarios, such as single engagement, range/velocity/latax (RVL), coverage boundary and performance contours to be selected.

In each of these scenarios the GUI facilitates the entry of various initialising parameters for the respective scenario.

In one example, in a Single Engagement scenario the GUI provides;

a missile selection box which can reference one of the available missile data files as previously disclosed;

attacker details such as its initial location (x, y, altitude);

velocity and heading; and

launch delay time in any concurrent manoeuvre (eg constant G's) by the launch aircraft.

Furthermore, the user can similarly enter target details such as those of the attacker.

Each entry required is provided default values for increased useability of the program.

For example in a Single Engagement scenario the GUI provides;

target details such as its initial location (x, y, altitude);

velocity and heading, azimuth, elevation, manoeuvre, horizontal latax, vertical latax and start manoeuvre delay.

Thus in this embodiment the GUI program at start-up initiates MECA and the class propagates the missile, attacker and target states using a predetermined integration scheme. The scenario is run in lock step with the timing units determined by the simulation and applied throughout the scenario.

It will be apparent to those skilled in the art that the interval step between cycles of calculation is time in this embodiment. However, it is possible in other systems to use a different interval. For example, in the calculation of a radar signature it will be necessary to use a spatial interval.

GEMM in this embodiment uses a 3 Degrees of Freedom (3DOF) generic missile flight-dynamics model capable of representing a wide range of aerodynamic airframes including, as described in this embodiment, missiles.

The three degrees of freedom are the three translational forces, X (axial), Y lateral yaw), Z (lateral pitch). Body moments and rotational accelerations are not calculated. Relative missile-target geometry is used by a guidance law to determine acceleration commands. The guidance laws use ideal geometric rates, there is no seeker processing or modelling. Two airframe models are available, zero order or Point-mass model (instantaneously achieved acceleration) and first order or Agile model (first order lagged acceleration). Body incidence is calculated from the achieved acceleration and used to determine induced drag for the Point-mass model and is used to resolve body forces for the agile model.

GEMM has a predetermined structure with flexible parameter definitions to propagate a missile's dynamic state. It has been designed generally so merely applying different numeric parameters can simulate those different missiles. The model is initialised with the target aircraft and attacker states at the time of launch and then propagated until intercept or failure. The target and attacker states can be updated at each propagation step. 6DOF models are also possible in this embodiment but are not described herein, neither are so called pseudo 5DOF models and variations thereof. Defence Force operational requirements are generally satisfied by the 3DOF model.

GEMM can be run using numeric values received on a physical or virtual data bus, built-in options or completely user-defined parameters.

The output of GEMM is provided to MECA and integrated into the scenario along with the attacker and target states.

Again it is important to note that both GEMM and MECA can operate stand-alone. It is also of importance that because of their modularity and the fact that they do not contain or need to contain classified information there is a large ease of use and distribution factor. They do not contain any sensitive data relating to the performance of missiles or aircraft. GEMM only contains generic predetermined characteristics that are used to determine the behaviour of an object, in this case a missile.

For simple simulations and analysis, object data files, in this embodiment, data files relating to well known missiles is supplied separately and are unclassified. In fact there exist publicly known missile parameters often used for simple simulations and demonstrations.

However, when the missile data file contains sensitive missile parameters it will be Defence Department classified and depending on its classification, the missile data file will require special physical handling procedures. For example, it may be that a classified missile data file may not be used on untrusted computers or computers that are not within a closed and controlled network or that its distribution will be restricted, etc.

Clearly, defence forces are used to handling classified information and have suitable procedures and environments for operating those types of programs. It is however, a much simpler undertaking to handle a data file in the manner required.

A missile data file can range in complexity from a simply structured text file to complex ALGOL-like programming language syntax.

In this embodiment of the invention the data file comprises numeric data, syntactic key words and user defined algorithmic expressions (SMART DATA) which equates to parameters not adequately represented as a constant scalar, or a tabular function of fixed independent variables, or by a suite of built-in options. The missile data files may include Smart Data comprising a particular user-defined code block that by its nature provides unlimited flexibility in characterising a particular missile system. Multiple files represent multiple missiles or other types of objects.

A benefit of the invention is that the fidelity of a model can easily be tailored to a scenario without changing or rebuilding the program that uses or executes the model.

A user defined code block is comprised of algorithmic expressions that with the assistance of a processing action, that for example is provided by a parser and a virtual machine (sometimes referred to as a StackMac virtual machine), are processed to produce a compiled code block which is dedicated to calculating an appropriate value for a missile parameter.

Smart Data allows a parameter to be specified with arbitrary logic and to be made a function of any other model parameter or variable. For example, the thrust parameter (which is usually specified as fixed function of time) could be defined with Smart Data to be a function of missile speed, altitude and angle-of-attack. Such a definition would allow the representation of an air-breathing engine without modification to the generic model.

FIG. 1 is merely a schematic overview of but one embodiment of the combination of, a GUI, MECA, GEMM and a data file for simulating the flight of a missile.

MECA classes include member functions to set all of the appropriate parameters prior to stepping through the engagement simulation. Examples of the member functions are ‘Specify the Missile Data File’ that contains all the missile specific parameters; ‘Set Initial Conditions‘ such as the Attacker/Target initial positions, velocity, altitude, manoeuvres and missile launch delay.

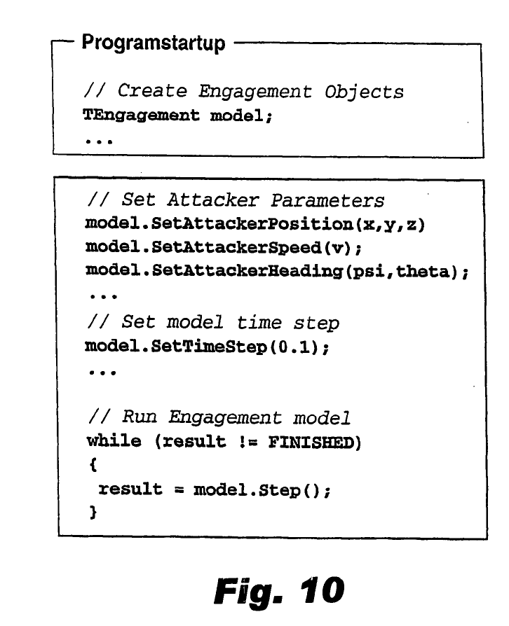

Simulation Controls such as integration time-step period, step simulation and run simulation to scenario completion are determined by a variety of triggers such as a preset time lapse or target destruction Simulation Results follow the simulation run/completion or in the event of an error, these results can also indicate a hit or a miss of the target. FIG. 10 depicts an example of some lines of code for initiating MECA.

Referring to FIG. 2 the output of MECA is supplied to the GUI and various displays of the engagement are available such as strip plots and 3D views from user definable view locations or raw data for off-line analysis. In real time simulations, MECA provides data, which is translated immediately into visual representations, and feedback from the user of the simulation is in turn supplied to MECA and then sent to the relevant kinematic and integrated functions of GEMM.

FIG. 2 depicts a schematic of the program modules, which provide the functionality of the engagement class. A Data Manager in GEMM loads missile data from the separate specified data file parsing it into an internal representation and also contains a StackMac for processing that information. The data is in effect, transferred from the file into the Data Manager but is made available to the rest of the software of the product via a virtual data bus as will be described later in the specification.

Thus, for example, the missile file syntax predetermines initialisation data such as mass, thrust, aerodynamic coefficients, latax capability and specific guidance laws. The Data Manager in GEMM has Read and Write permission's for variables on the data bus and on an initial read provides those variables to the first of many kinematic equations which are available to the missile model.

The Data Manager also provides the flexibility of having if required multiple blocks of the same type and is able to dynamically switch between them based on simulation parameters and logical expressions encountered during simulation execution. For example, gas turbine powered missiles with a solid rocket booster can have two propulsion blocks, one being a standard thrust vs. time table, the second being a user-defined block giving thrust as a function of operating parameters. The Data manager provides the ability to select the correct propulsion block at run-time.

In GEMM the kinematic equations are applied and are also acted upon by the guidance laws applicable to the missile. Typically a predetermined number of guidance laws exist which are applicable to most missiles and each guidance law is precompiled from C++ code as part of the generic missile model and ready to operate given the required parameters. This is different from the previously described user-defined guidance laws that are compiled from the data file by the Data Manager.

This embodiment of the invention provides, as described previously, a means for user defined code blocks to be immediately parsed and used by a StackMac.

The parser/compiler within the Data Manager may compile code modules for use in the StackMac virtual machine as instructions that are executed and provide data back to the missile model being executed in GEMM. The calculated parameter values continue to be used in the required model equation within the time-step until the missile model stops or returns to the beginning of the process ready for the next time-step to commence. Having generated the applicable parameter values, they may be written by the data manager to the data bus so that other elements of GEMM can use them as required.

Kinematic equations may provide as output—the target, attacker and missile derivatives as well as the relative geometry between these three objects.

MECA may include a control functionality which orchestrates the functions of the Data Manager in GEMM and integration of each of the attacker, target missile states into the scenario in step with the time-step of MECA and other time intervals relating to the virtual data bus and the GUI/interface.

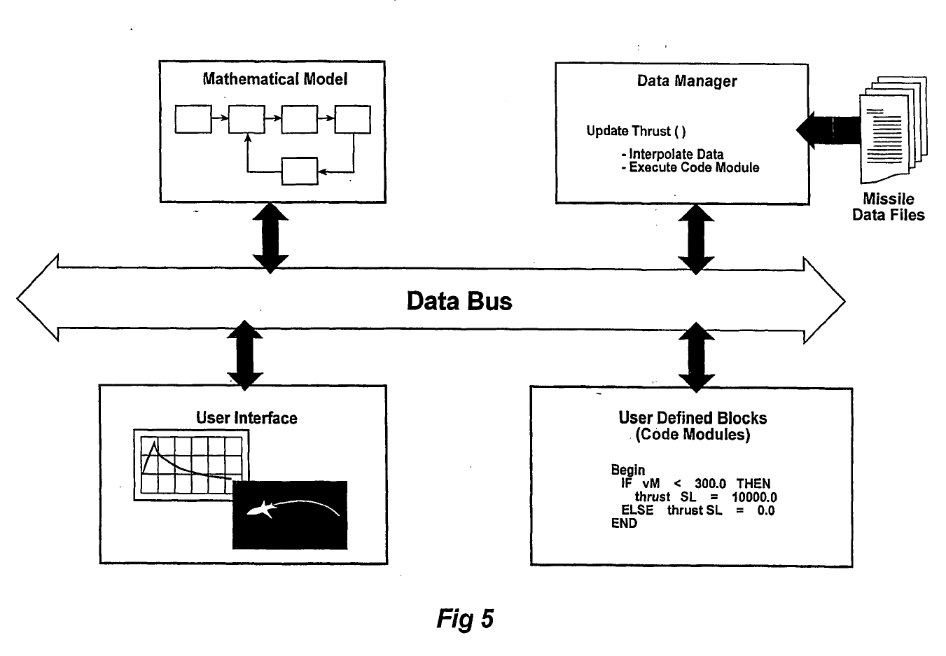

As briefly described previously, the data bus pictorially represented in FIG. 5 is actually a data structure rather than a physical bus. This bus may be arranged to allow model variables to be shared amongst the many equations used in the missile engagement model class as well as between this class and the Data Manager, user-defined code blocks and the GUI.

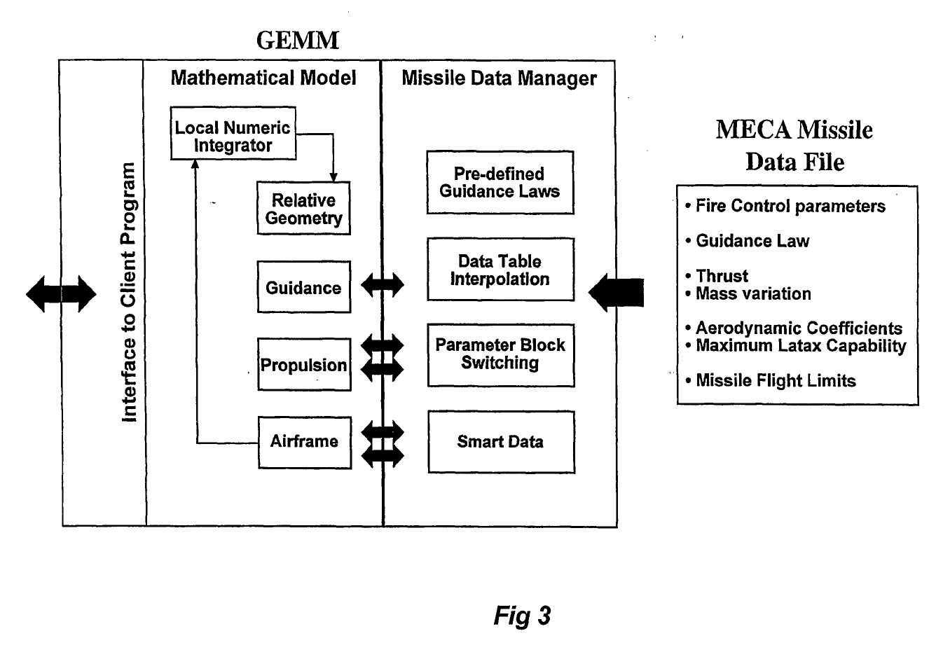

FIG. 3 illustrates the components of GEMM and the type of parameters that are read from the MECA Missile Data File that drives the generic model. Parameters may be specified using one of several built-in formats or may be given as Smart Data.

The mathematical Model portion of GEMM contains a Local Numeric Integrator that draws on the input from models of the Relative Geometry of the object, Guidance, Propulsion and Airframe equations that in this embodiment relate to a missile.

The Missile Data manager portion of GEMM contains Pre-defined Guidance Laws, Data Table Interpolation, Parameter Block Switching and Smart Data as constructed from data in the Missile Data File.

The Missile Data file may contain scalar values, tables with fixed independent variables and user-definable code representative of control parameters, guidance laws, thrust, mass variation, aerodynamic coefficients, maximum latex capability and missile flight limits.

In terms of programming requirements GEMM is defined by the class TGeneric3DOFMissile. This class contains public member functions that provide an interface to the external program for setting up and running the missile model.

The TGeneric3DOF Missile class contains a few major sub-components:
Generic Missile dynamics model
Databus
Missile Data Manager
Stack Machine (StackMac)
Parser

The Generic Missile Dynamics model is an enhanced 3DOF representation of an aerodynamically controlled missile. The class TMiss3DOF defines this component.

The Databus component is a data structure that holds all the missile model variables, providing a central location for all variables that must be accessible from the different components of the model. The class TDatabusInterface defines a generic Databus class. As described previously this is an empty virtual Databus that variables can be dynamically added to. The class TMECADatabus is derived from TDatabusInterface and all of the generic missile model variables are dynamically allocated in the constructor of this derived class.

The Missile Data Manager component is an object that stores all of the missile specific data and abstracts the details of this data away from the general missile dynamic component. A virtual Missile Data manager class TDataManager defines the interface between the generic missile dynamics component and the Data Manager. A new class, TMECADataManager is derived from TDataManager. This class provides the functionality to read Missile Data Files, store the data given the data file and provide this data to the other components as required. TMECADataManager includes functions that define the syntax for the Missile Data Files.

The StackMac component implements the User-defined parameter facility available in the Missile Data Files. This facility allows many of the missile specific parameters to be “user-defined” rather than being restricted to scalar of tabular numeric values. User-defined parameters can be specified using any arbitrary logic and may be considered as program functions or subroutines. This provides flexibility in the way the Missile Data File can be tailored to represent a specific missile. StackMac defines a class called TCodeModule that includes functions to parse User_Defined blocks in text files and to execute these blocks at run-time. The parser component provides a set of basic parsing utility functions that are used by the StackMac and the Missile Data Manager components.

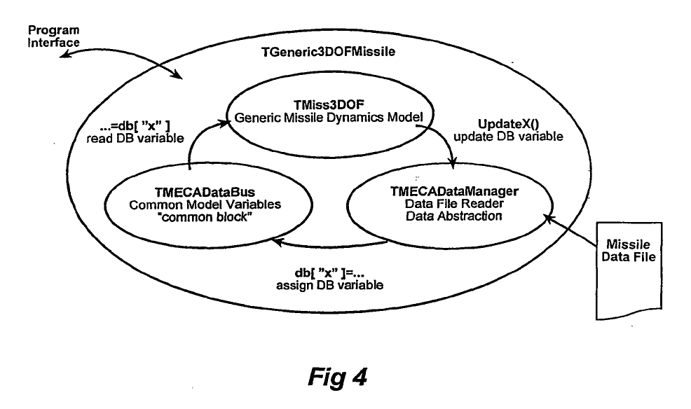

FIG. 4 depicts the relationships between the sub-components of GEMM wherein the Generic Missile Model class TGeneric3DOFMissile, contains one object type TMiss3DOF, one object of type TMECADatabus and one object of type TMECADataManager. These objects are dynamically allocated in the constructor of TGeneric3DOFMissile.

TMiss3DOF is defined and implemented in files named miss3dof.h and miss3dof.ccp. This is a generic missile model that does not contain any missile specific data. Missile specific data is obtained by calling data-update function from the Data Manager object. The Data Manager writes the required data to the Databus object, from which the dynamics block reads the updated values.

TMiss3DOF is derived from class TIntegrator, a generic numerical integration class. This is defined and implemented in integ.h and integ.ccp. TIntegrator contains a virtual function definition Derivative( ) which is overridden in implementation of TMiss3DOF. This function contains the differential equations of the missile dynamic model.

TMECADataManager is defined and implemented in files named “missdef.h’ and “missdef.cpp. This class contains data structures to store all of the parameters loaded from a missile data file. This class performs the following operations: read or parse the missile data file; store the data; provide the data as required to the missile dynamics model. TMECADataManager defines the missile data file syntax and abstracts the data file details from the generic missile model.

The Data Manager class uses parsing tools defined in a separate set of files, collectively called Parser. These tools implement basic functionality such as GetNextToken or SkipToken, etc. TMECADataManager defines the keywords, numbers and tables that are used in the missile data file and the syntax of these files.

The Data Manager also uses another component called StackMac that provides the User-Defined functionality of the missile data files. StackMac uses the parser tools to define the User-Defined syntax and implement the user-defined logic at run time.

TMECADataBus is a data structure that holds all the common model variables. This includes all missile dynamic variables, relative geometry variables, and target and attacker state variables.

The purpose of the TMECADataBus object is to have a single storage point and declaration point for all model variables that includes the numeric value of the variable, a string name, a string description and a unit category (eg. Distance, speed, mass etc.).

The string name of a variable is required when parsing a user-defined code module with StackMac. User-defined code modules have access to all model variables identify these variables by the string name. The string name is also used when displaying the list of trace variables in the MECA user interface. The MECA user interface was designed to be as separate from the missile engagement model as possible. At run time, the MECA user interface code determines from the Databus a list of variables to display in the usr trace variable list. The GUI obtains the string names and pop-up description strings from the Databus.

TMiss3Dof is defined and implemented in files named miss3dof.h and miss3dof.cpp.

TMiss3DOF implements a time-step-integrated model of an aerodynamically controlled missile. This class is derived from the general-purpose numeric-integration class TIntegrator.

TIntegrator contains a virtual “Derivative” function and several fixed time-step numeric integration methods (Euler, Runge-Kutta 2.sup.nd order, Runge-Kutta 4.sup.th order). To use these integration methods, a specific model class is derived from TIntegrator that includes a new Derivative function. The Derivative functions contain the differential equations of the model. Integration variables are designated within the Derivative function by making calls to the base class member function Integrate.

To propagate the model, one of the integration method functions (Euler, Runge-Kutta 2.sup.nd order, Runge-Kutta 4.sup.th order) are called, once for each time-step. The integration function will make one or more calls to the new Derivative function for each time step. Call backs in the Derivative function to the Integrate function causes a new array of pointers to the integration variables to be constructed every time-step. At the end of the integration function call, the integration variables are updated via the array of pointers. This implementation allows new integration variables to be easily added to the model and the actual number of integration variables can vary between time-steps.

The Derivative function of TMiss3DOF is split up into a number of other functions that represent the different components of the missile. When the Derivative function is called, these functions are simply called in appropriate order. These functions include Guidance (preliminary guidance calculation), Propulsion, Point Mass Airframe, AgileAir Frame and Missile Motion. These functions implement a completely generic missile model. When a missile specific parameter is required (for example, acceleration demand, thrust force, axial drag coefficient) a call is made to one of the Update functions of the GEMM Data manager. The Data Manager responds to the Update function by updating the appropriate variable in the MECA Databus. The generic missile model then uses this update value and the Derivative function continues.

Note that all missile specific details have been removed from the generic model component. Such items as guidance laws (PN, Pursuit, User-Defined, . . . ) are missile specific. These are defined in the Data Manager component.

The numeric integration method Runge-Kutta 4.sup.th order is preferably used to integrate the generic missile model. This is called once every time the public Propagate function of the class TGeneric3DOFMissile is called. This is the main interface function to the external program to propagate the missile model forward in time.

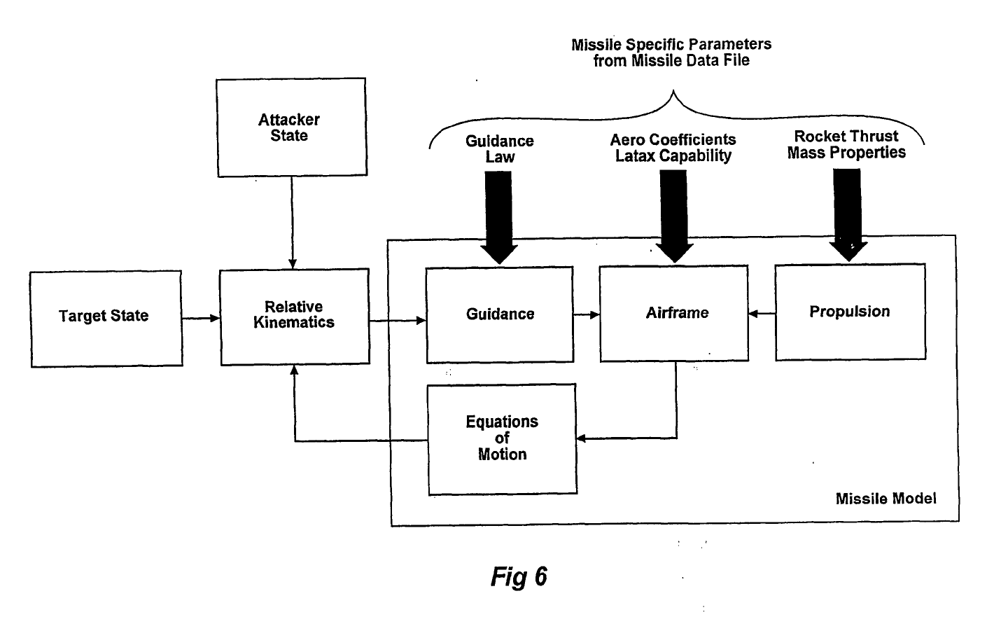

FIGS. 5 and 6 depict functional blocks of the missile model in GEMM indicating that missile specific parameters are provided by the missile data file such as missile thrust, mass properties, aerodynamic coefficients and LATAX capabilities and applicable guidance laws. GEMM also accepts the results of the prior calculations and the relative kinematics of various objects.

Although the data flow arrows are depicted having particular orientations, such as guidance to airframe and propulsion to airframe and airframe to equations of motion, those shown are but one embodiment of an arrangement.

As also depicted in FIGS. 5 and 6 the Data Manager supplies data from the data bus and missile data files to the missile model, which contains the various equations that act upon the various parameters for the current time-step.

As described previously, one or more precompiled guidance laws may be applicable and when required user-defined guidance laws can be included in the missile files to account for a variety of situations. Such as for example, when a known guidance law appears no longer to apply to a missile as a result of missile improvements. An estimate or an appropriate guidance law can be substituted in the missile data file without having to change in any way the generic missile model or MECA.

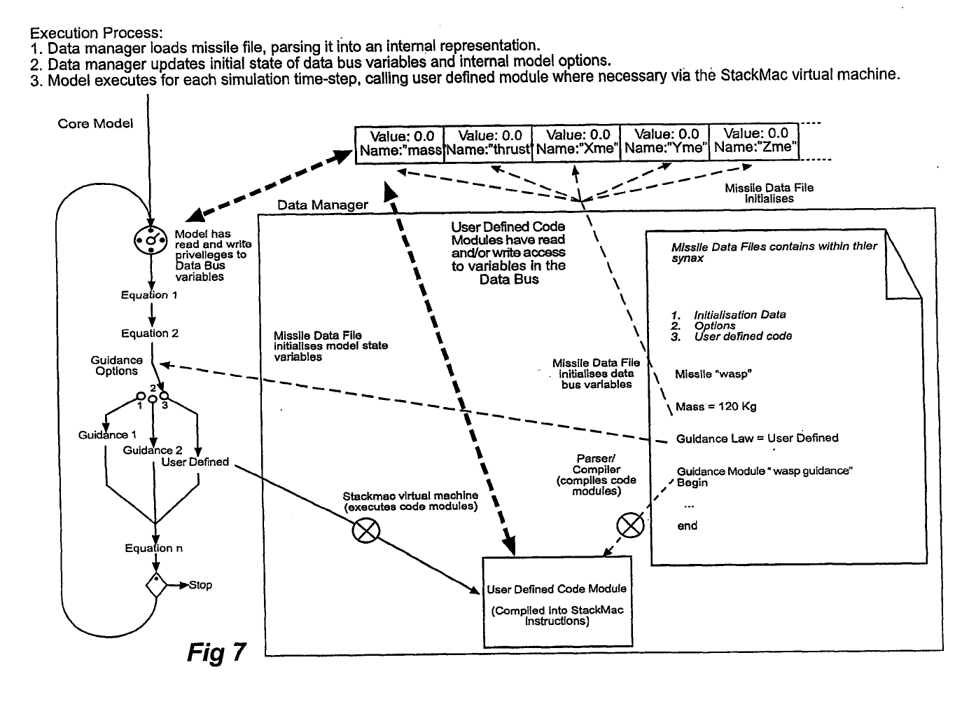

FIG. 7 depicts an example of the operation of a parser which loads and verifies missile data files. The parser is arranged to identify in the missile data file (which is typically a text file typically containing scalar values, tables with fixed independent variables) or key words (eg NAVIGATION_GAIN 4.0). The parser also identifies user-defined code blocks and builds them into a representation that is executable by a StackMac.

Thus it will be appreciated that the missile data file can be a very flexible medium for defining missile parameters. Clearly, this flexibility is also useful in modelling other environments and objects.

Not only is the file text based, the syntax used will be familiar to programmers. The file is also inherently portable and suitable or transmission with the requisite amount of security, as it can be readily classified, encrypted and handled in ways familiar to military personnel.

Data files are stored in any suitable data storage means, typically on a CD ROM.

In this embodiment, the user-defined code blocks contain ALGOL-type statements and have read access to all model variables and write access to the specific variable being calculated. At any one time the StackMac executes the user-defined code which assigns a value to the missile parameter.

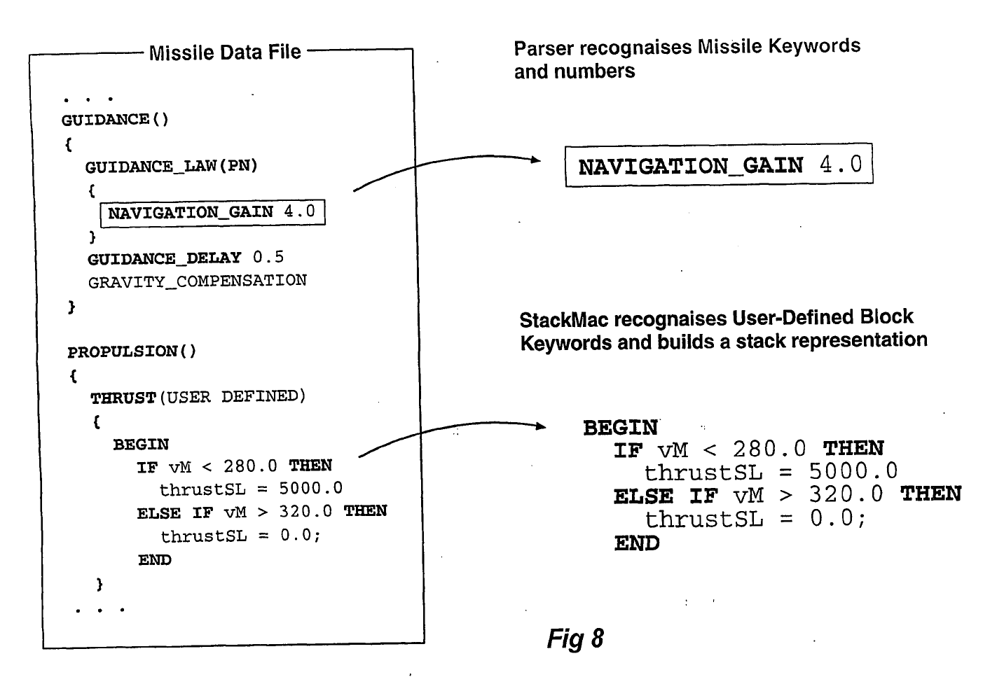

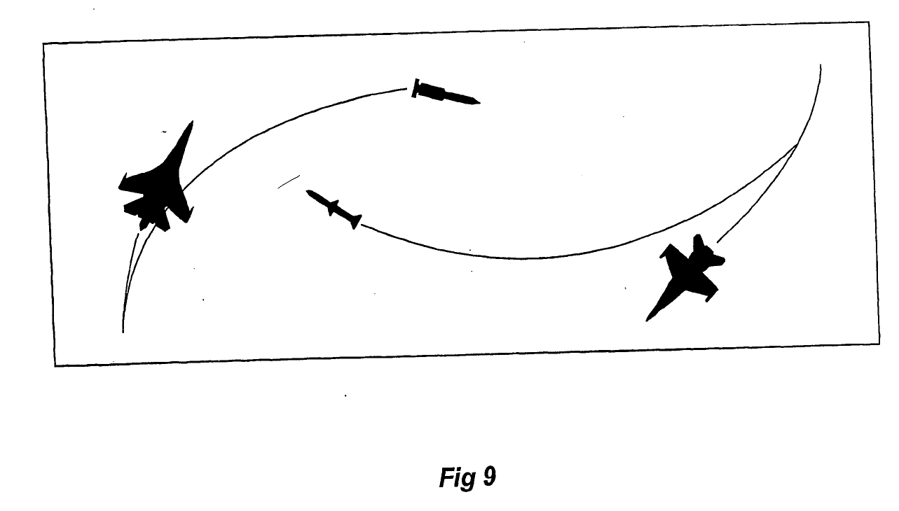

Thus, using the code example provided in FIG. 8, the parameter, THRUST is required by the model. Values of THRUST could have been available from a look-up table versus time plot but, in this example, a user-defined block of code specifies the parameter of THRUST. The user-defined block starts and finishes with the key words Begin and End and contains ALGOL-type statements. The user-defined block has Read access to model variables such as .nu.M (missile velocity) and must be able to Write to a model variable, in this example, THRUST SL (missile sea level thrust).

Various way of illustrating the functionality of GEMM are available and for the purpose of illustration only, an aircraft combat scenario is made available using a GUI designed for that purpose. This embodiment does not use MECA as is described in detail in this specification but there are similar elements and principles. GEM is merely a provider of calculated numbers based on various generic models available to it and specific object data available from data files for the specific objects say for example, attacker aircraft and its missiles as well as friendly aircraft and its missiles.

In a one-on-one simulation as pictorially represented in 2D in FIG. 9 two aircraft and two missiles are involved. Two objects of class TAircraft (Red and Blue) and two objects of class TMissile are handled in the simulation. Each TMissile object is initiated with data from a respective missile data file to simulate its characteristics.

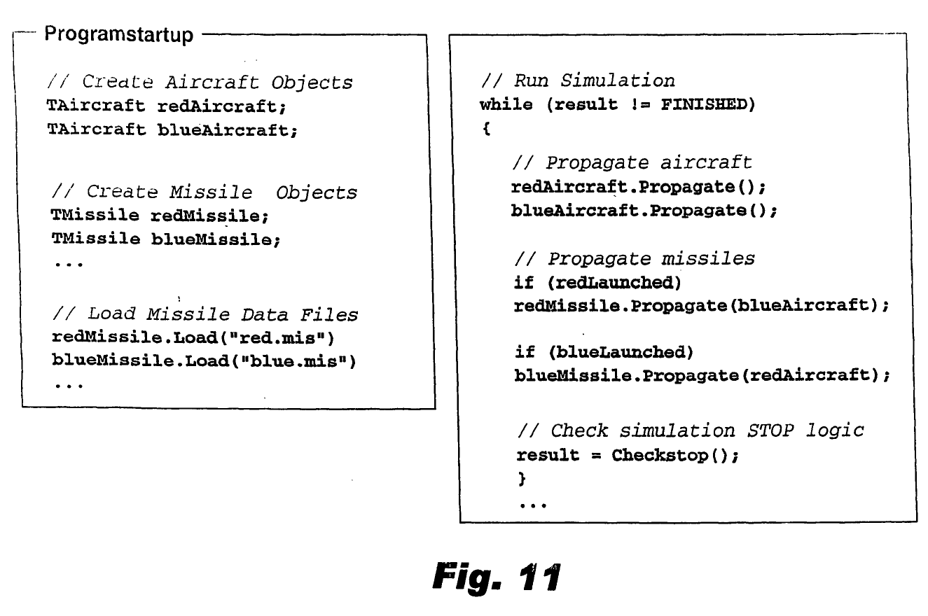

As shown in FIG. 11, the red missile is propagated through the class by passing the blue aircraft state as its target and the blue missile is propagated by passing the red aircraft state as its target. The scenario is advanced by a predefined time step until either of the missiles miss or hit their intended target. All of the steps are visualised and the user is thus better informed of the capabilities of the aircraft and the missiles in a combat situation.

It will be appreciated by those skilled in the art, the invention is not restricted in its use to a particular application described and neither is the present invention restricted in its preferred embodiment with regard to the particular elements and/or features described or depicted herein. It will be appreciated that various modifications can be made without departing from the principles of the invention, therefore, the invention should be understood to include all such modifications within its scope.

1. A method for representing on a computer the behaviour of a system having at least one element, said system being represented on the computer by executing a compiled generic description, a generic description comprising predetermined characteristics that affect the behaviour of one or more elements of said system in a predetermined environment; and a data file that contains one or more sets of numeric data and/or syntactic key words and/or a user defined algorithmic expression all related to a said predetermined characteristic being data that is not included in the complied version of the generic description, said method comprising the step of:
execution of the compiled generic description using an interval that uses data from the data file without recompiling the generic description to include the data obtained from the data file so as to calculate data that represents how said system would behave if actually operating in the real world.

2. A method according to claim 1 wherein said predetermined characteristics are defined by equations of motion based on a predetermined number of degrees of freedom of motion.

3. A method according to claim 1 wherein said execution includes an interval step integration of the one or more elements in said system using one or more of said contents of said data file.

4. A method according to claim 3 wherein said interval is time.

5. A method according to claim 4 wherein said execution includes at least one derivative function and at least one time interval step numeric integration method.

6. A method according to claim 5 wherein a said integration method is used once every time interval step.

7. A method according to claim 6 wherein said derivative function is used by said integration method one or more times every time interval step.

8. A method according to claim 7 wherein following each time interval step an array of one or more pointers to integration variables is updated allowing further integration variables to be created between time-steps.

9. A method according to claim 5 wherein said integration method comprises a predetermined number of system element generic descriptions.

10. A method according to claim 9 wherein said predetermined numbers of system element generic descriptions are ordered for use by said derivative function.

11. A method according to claim 10 wherein when an element specific parameter in said execution is required, reference is made to data in said data file.

12. A method according to claim 1 further comprising the step of:
b) managing the flow of data to and from said execution step with a data manager.

13. A method according to claim 12 wherein said data manager controls the reading of data from said data file and the placing of that data on a virtual data bus.

14. A method according to claim 13 wherein when an element specific parameter in said execution is required, reference is made to data on said data bus.

15. A method according to claim 10 wherein when an element specific parameter in said execution is required, reference is made to data on said data bus.

16. A method according to claim 1 wherein said user defined algorithmic expression comprises arbitrary logic having dependence on none, one or more sets of numeric data and/or syntactic key words.

17. A method according to claim 16 wherein element specific-parameters are defined in a said user defined algorithmic expression and comprise executable mathematical equations and respective data relating to a specific class of element.

18. A method according to claim 17 wherein said mathematical equations are guidance laws specific to a said class of element.

19. A method according to claim 1 wherein the result of said execution step is numeric values representative of the behaviour of said system.

20. A method according to claim 1 wherein said execution step includes executing a C++ class object that includes said compiled generic description.

21. A method according to claim 20 wherein said C++ class object provides entry points to set the initial values of predetermined characteristics.

22. A system for providing numerical output representative of the behaviour of a system comprising:
a first data storage containing one or more programs of compiled generic system descriptions each having predetermined characteristics that affect the behaviour of said system in a predetermined environment;
a second data storage containing at least a data file that contains one or more sets of numeric data and/or syntactic key words and/or a user defined algorithmic expression all related to a said predetermined characteristic being data that is not included in the complied version of the generic description; and
a data processor to execute a said program obtained from said first data storage using said complied generic description with a predetermined interval to calculate data that represents how said system would behave if actually operating in the real world and using data obtained from said data file without recompiling the generic description to include the data obtained from the data file to calculate the behaviour of said system.

23. A system according to claim 22 wherein said predetermined characteristics are defined by equations of motion based on a predetermined number of degrees of freedom of motion.

24. A system according to claim 22 wherein said execution includes an interval step integration of the one or more elements in a said system using one or more of said contents of said data file.

25. A system according to claim 23 wherein said interval is time.

26. A system according to claim 24 wherein said execution includes at least one derivative function and at least one time-step numeric integration method.

27. A system according to claim 25 wherein a said integration is used once every time interval.

28. A system according to claim 26 wherein said derivative function is used by said integration method one or more times every time-step.

29. A system according to claim 27 wherein following each time-step an array of one or more pointers to integration variables is updated allowing further integration variables to be created between time-steps.

30. A system according to claim 25 wherein said integration function comprises a predetermined number of system element generic descriptions.

31. A system according to claim 29 wherein said predetermined numbers of system element generic descriptions are ordered for use by said derivative function.

32. A system according to claim 30 wherein when an element specific parameter in said calculation is required, reference is made to data in said data file.

33. A system according to claim 22 further comprising a data manager for managing the flow of data to and from said data processor.

34. A system according to claim 33 wherein said data manager controls the reading of data from said data file and the placing of that data on a virtual data bus with in the data processor.

35. A system according to claim 30 wherein when an element specific parameter in said calculation is required, reference is made to data on said virtual data bus.

36. A system according to claim 33 wherein when an element specific parameter in said calculation is required, reference is made to data on said virtual data bus.

37. A system according to claim 22 wherein said user defined algorithmic expression comprises arbitrary logic having dependence on none, one or more sets of numeric data and/or syntactic key words.

38. A system according to claim 35 wherein element specific parameters are defined in a said user defined algorithmic expression and comprise executable mathematical equations and respective data relating to a specific class of element.

39. A system according to claim 37 wherein said mathematical equations are guidance laws specific to a said class of element.

40. A system according to claim 22 wherein said execution includes executing a C++ class object that includes said complied generic description.

41. A system according to claim 40 wherein said C++ class object provides entry points to set the initial values of predetermined characteristics.
